(19) United States
(12) Patent Application Publication
(10) Pub. No.: US 2023/0116720 A1
(43) Pub. Date: Apr. 13, 2023

(54) Integrated Control System for Edge Devices

(71) Applicants: Ye Lu, Coquitlam (CA); Him Wai Ng, Port Coquitlam (CA); Zhen Wang, Vancouver (CA)

(72) Inventors: Ye Lu, Coquitlam (CA); Him Wai Ng, Port Coquitlam (CA); Zhen Wang, Vancouver (CA)

(21) Appl. No.: 17/499,828

(22) Filed: Oct. 12, 2021

(51) Int. Cl. G06F 8/34; G06F 3/0484; G06F 3/0486

(52) U.S. Cl. CPC G06F 8/34; G06F 3/04842; G06F 3/0486

(57) ABSTRACT

Various embodiments facilitate a user to program and control one or more devices through a control system. In some embodiments, an interface is provided to enable the user to manipulate one or more program elements graphically. The one or more program elements include a first program element corresponding to the task, and a user input is provided by the user through a user manipulation of the first program element in the interface. The user manipulation comprises drag and drop, voice control, gesture control and/or any other mode of control. In those embodiments, the user input is then converted a first code understandable to the control system. The first code is then transmitted to the control system through a communication protocol. After the first code is received, a first instruction is generated by the control system and is transmitted to an end device for execution by the first instruction.

### FIELD OF THE INVENTION

This invention relates to a control system for devices and more particular to facilitating a user to program and control devices using the control system.

### BACKGROUND OF THE INVENTION

A control system is a system of devices which manages, commands, directs, or regulates behavior of one or more end devices or end systems. A control system uses its computing capability to produce desired outputs for controlling one or more end devices or end systems. Examples of control system can range from a single home heating controller using a thermostat controlling a domestic boiler to large industrial control systems which are used for controlling processes or machines.

A programming language is a formal computer language used for instructing a computer or a computing device to perform specific tasks. Examples of programming language may include C language, C++ language, JavaScript, Java, Python and/or any other types of programming languages.

### SUMMARY OF THE INVENTION

One motivation behind the present disclosure is to implement a user-friendly and intuitive programming interface for users of a control system for end devices. In various embodiments, a graphical user interface implementing a visual programming language (VPL) is provided to enable users to program a control system to perform a specific task. In various embodiments, the graphical interface in accordance with the present disclosure comprises interface elements facilitating visual expressions, drag and drop manipulation, spatial arrangements of text and graphic symbols, and/or any other types of VPL manipulations.

Various embodiments facilitate a user to program and control one or more end devices through a control system. In those embodiments, an interface is provided to enable the user to manipulate one or more program elements graphically. The one or more program elements include a first program element corresponding to the task, and a user input is provided by the user through a user manipulation of the first program element in the interface. The user manipulation comprises drag and drop, voice control, gesture control and/or any other mode of control. In those embodiments, the user input is then converted to a first code understandable to the control system. The first code is then transmitted to the control system through a communication protocol. After the first code is received, a first instruction is generated by the control system and is transmitted to an end device for execution by the first instruction.

In some embodiments, the first instruction generated by the control system is at least a part of a simulated human intelligence process, which includes robot control, natural language processing, smart home device control, speech recognition, face recognition, image processing and/or image processing. In those embodiments, the interface in accordance with the present disclosure enables the user to instruct the system to implement the human intelligence process and generate one or more instructions including the first instruction to cause the end device to execute a task of the process on the device.

In some embodiments, the user input provided at the interface is verified to ensure the user input is implementable by the system. In some embodiments, messages are presented to the user indicating one more reasons why the user input is not implementable by the system so to enable the user to provide a new user input. In some embodiments, the system is configured to initialize the end device, obtain a status of the end device, and update the status of the end device from time to time. In those embodiments, the system is configured to verify the user input based on the status of the end device.

Other objects and advantages of the invention will be apparent to those skilled in the art based on the following drawings and detailed description.

### BRIEF DESCRIPTION OF THE DRAWINGS

FIG. 1A illustrates an example of the integrated control architecture in accordance with the disclosure.

FIG. 1B illustrates another example of the integrated control architecture.

FIG. 2 illustrates an embodiment of an interface shown in FIG. 1A.

FIG. 3 illustrates an embodiment of software architecture of the integrated control architecture in accordance with the disclosure.

FIG. 4 illustrates an embodiment for a user input conversion module of the software architecture in accordance with the disclosure.

FIG. 5A illustrates an embodiment for a message queuing telemetry transport broker in accordance with the disclosure.

FIG. 5B illustrates another embodiment for the message queuing telemetry transport broker.

FIG. 6 illustrates an embodiment for a direct serial communication channel in accordance with the disclosure.

FIG. 7 illustrates a simplified computer system that can be used to implement various embodiments described and illustrated herein.

FIG. 8 illustrates an example method for facilitating a user to cause an end device to perform one or more tasks in accordance with the disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. For a particular repeated reference numeral, cross-reference may be made for its structure and/or function described and illustrated herein.

As computing capability of a control system to control an end device is typically provided by one or more electronic processors, for users of such a control system, it is required that they possess adequate programming language skills in order to design specific applications for controlling an end device. Users of a control system may be required to have dedicated training in one or more programming languages in order to possess adequate programming skills to design applications of a control system, which has become one of the major obstacles for kids to learn and practice design of control systems at an early age. Designing applications for control systems using complex programming languages is also a time-consuming and error-prone process for novice programmers as the syntax of a programming language may be complicated for novice programmers. Moreover, it may not be necessary for functional designers of such a control system to be skilled in complex programming languages in order to design applications in the control system. For functional designers of such as a control system, the goal is to provide a functional solution of a specific application using the control system without spending time in going through details of the programming language used in the control system.

One motivation behind the present disclosure is to implement a user-friendly and intuitive programming interface for users of a control system for edge devices. In various embodiments, a graphical user interface implementing a visual programming language (VPL) is provided to enable users to program a control system to perform a specific task. In various embodiments, the graphical interface in accordance with the present disclosure comprises interface elements facilitating visual expressions, drag and drop manipulation, spatial arrangements of text and graphic symbols, and/or any other types of VPL manipulations.

Among other benefits, such a graphical user interface does not require users to learn and write codes using more complex programming languages (as compared to VPL). Such an interface provides users an easy and efficient tool. For kids, such an interface allows them to learn and practice programing, robotic control, device control and/or any other applications. In this way, interests of kids in learning more details on control systems and programming languages can be cultivated at an early age. For novice programmers, such an intuitive interface allows them to execute and test their programs in a quick and efficient manner without going through the lengthy learning curve for mastering a programming language and the tedious debugging process at program development stage. For functional designers, such an interface allows them to provide functional solutions of a specific application without spending time in going through details of the programming language used in the control system.

Another motivation behind the present disclosure is to provide a software system for facilitating users controlling a system to perform a task on one or more end devices through VPL. In various embodiments, the software system in accordance with the present disclosure allows users to control the one or more end devices from an interface to perform multiple tasks simultaneously. In those embodiments, the software system is configured to map user requests to task modules, and generate instructions to enable the one or more end devices to perform corresponding specific tasks in an efficient and coordinated manner.

Still another motivation behind the present disclosure is to implement verification mechanism to facilitate users using the interface in accordance with the present disclosure. As mentioned above, the interface in accordance with the present disclosure provides access to wider user base that can include kids, novice users, functional designers, and/or any other types of non-experienced users. It is important that users of the interface in accordance with the present disclosure is provided verification mechanism to “guide” them when controlling the system to perform one or more tasks on one or more end devices. In some embodiments, such a mechanism includes verifying correctness of user manipulations according to a set of rules for manipulating program elements in the interface in accordance with the present disclosure. In some embodiments, the interface in accordance with the present disclosure provides a visual display showing the verification to assist the users in identifying and correcting programming errors in the control system.

Among other benefits, such manipulation correctness verification can allow kids to learn and practice applications of the systems more efficiently with guided manipulations at the interface. For novice programmers, such user manipulation correctness verification can serve as a programming debugger to assist them in identifying and correcting programming errors without knowledge and skills in complex programming languages. For functional designers, such user manipulation correctness v can provide a fast and efficient tool in debugging their programs without going through details of programming language used in the control system.

### Example System Architecture

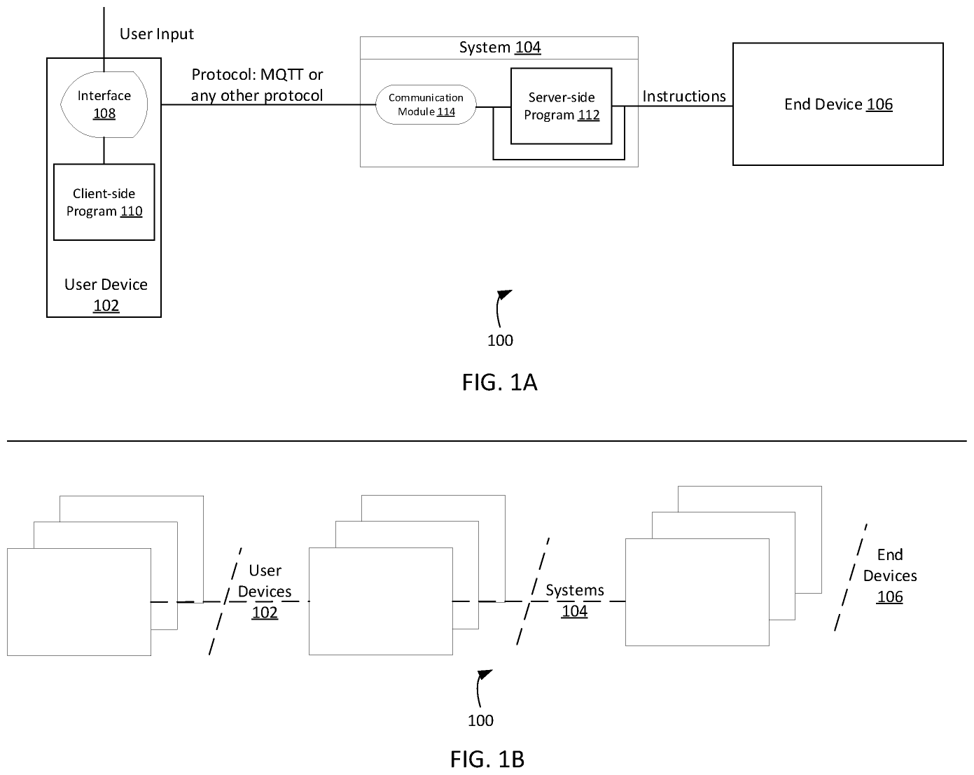

FIG. 1A illustrates an example of an integrated control architecture 100 for enabling a user to control an end device to perform a task in accordance with the present disclosure. As shown, in this example, the integrated control architecture 100 includes a user device 102, a system 104, an end device 106, and/or any other components. The user device 102 may be referred to a device configured to receive/obtain a user input from a user of the integrated control architecture 100, communicate with other components of the integrated control architecture 100, and interact with the user by providing feedback from other components of the integrated control architecture 100. Examples of the user device 102 may include a smart device, a tablet, a laptop computer, a desktop computer, and/or any other types of user device.

In this example, the user device 102 comprises an interface 108, a client-side program 110, and/or any other components. The interface 108 may be referred to a part of the user device 102 where interactions between the user and the user device 102 occur. Examples of the interface 108 may include graphical user interface, text-based user interface, command-line interface, voice-user interface, and/or any other types of interface. The client-side program 110 may be referred to a program at the user device 102 configured to manage operations in the user device 102.

The interface 108 may be configured to receive/obtain a user input provided by the user of the integrated control architecture 100. In this example, the user input comprises a user manipulation of one or more program elements in the interface 108 corresponding to one or more task categories performed at the end device 106. Examples of user manipulation of one or more program elements in the interface 108 may include drag and drop, voice control, gesture control, and/or any other types of user manipulations.

The client-side program 110 may be configured to communicate with interface 108, and convert one or more user manipulations received/obtained at interface 108 to a first code understandable to the system 104. Examples of first code understandable to the system 104 may include Python code, C language code, C++ language code, JavaScript code, and/or any other types of code understandable to the system 104.

The system 104 may be referred to a system comprising one or more processors, one or more storage elements, one or more buses, and/or any other input/output peripheral devices to perform a dedicated function within a larger mechanical or electronic system. Examples of the system 104 may include reduced instruction set computer (RISC)-based single-board computer, Advanced RISC Machines (ARM)-based single-board computer, complex instruction set computer (CISC)-based single-board computer, and/or any other types of systems.

In some embodiments, the first code understandable to the system 104 is transmitted from the user device 102 to the system 104 using a communication protocol. A communication protocol may be referred to a set of formal descriptions of transmission message formats and rules between communication entities. Examples of communication protocol may include transmission control protocol (TCP), internet protocol (IP), hypertext transfer protocol (HTTP), message queuing telemetry transport (MQTT) protocol, and/or any other types of communication protocols.

In the example shown in FIG. 1A, the system 104 comprises a communication module 114, a server-side program 112, and/or any other components. The communication module 114 may be referred to a module in the system 104 configured to facilitate communication between the user device 102, the system 104, the end device 106, and/or any other devices in the integrated control architecture 100. Examples of the communication module 114 may include a communication initialization function, a protocol setup function, a source setup function, a destination setup function, a communication status check function, and/or any other functions. The server-side program 112 may be referred to a computer program at the system 104 configured to manage operations in the system 104.

In this example, the server-side program 112 is configured to receive/obtain the first code understandable to the system 104 from the user device 102 through the communication module 114 and generate a first instruction to the end device 106. A first instruction to the end device 106 may be referred to an instruction transmitted to an end device 106 for controlling operations in an end device 106. Examples of a first instruction to the end device 106 may include an end device initialization instruction, an end device setup instruction, an end device enable instruction, an end device pause instruction, an end device disable instruction, and/or any other instructions. In various implementation, the first instruction may be a part of a simulated human intelligence process (e.g., an AI program). For instance, the first instruction may be part of a robot control process to control an end device, which is a robot. As another non-limiting example, the first instruction may be part of a voice recognition process to cause the end device, which has an audio collection capability, to collect audio for the system to process. Other examples are contemplated.

An end device 106 may be referred to a device configured to perform a specific task category corresponding to a program element in the interface 108. Examples of the end device 106 may include robot, motor, camera, voice recorder, smart home device, and/or any other types of end devices. Examples of task categories performed at the end device 106 may include robot control, motor control, natural language processing, smart home device control, speech-to-text and text-to-speed conversion, face recognition, voice recognition, and/or any other types of task category.

FIG. 1B illustrates another embodiment of the integrated control architecture 100. In this embodiment, the integrated control architecture 100 includes a set of user devices 102, a set of systems 104, a set of end devices 106, and/or any other components. In this embodiment, the user devices 102 are operatively connected to the systems 104, and the systems 104 are operatively connected to end devices 106. Please reference FIG. 1A and its associated texts for example structure and functions for the user devices 102, the systems 104 and the end devices 106 illustrated in FIG. 1B.

### Example Interface

In accordance with the present disclosure, an interface is provided on a device to enable a user to provide inputs to cause one or more tasks to be performed on an end device separate and distinct from the device where the user provides the input. For example, such an interface can be implemented on the user device 102 shown in FIG. 1A. As mentioned above, the interface in accordance with the present disclosure can include program elements manipulated by the user. In a sense, such an interface is not simply an interface where the user provides programming codes to cause the end device to perform the one or more tasks. The interface, in accordance with the present disclosure, provides an intuitive programing front even to a novice user like a child or a non-experienced user such as a designer, whom may not be skilled to provide programming codes, for example in python.

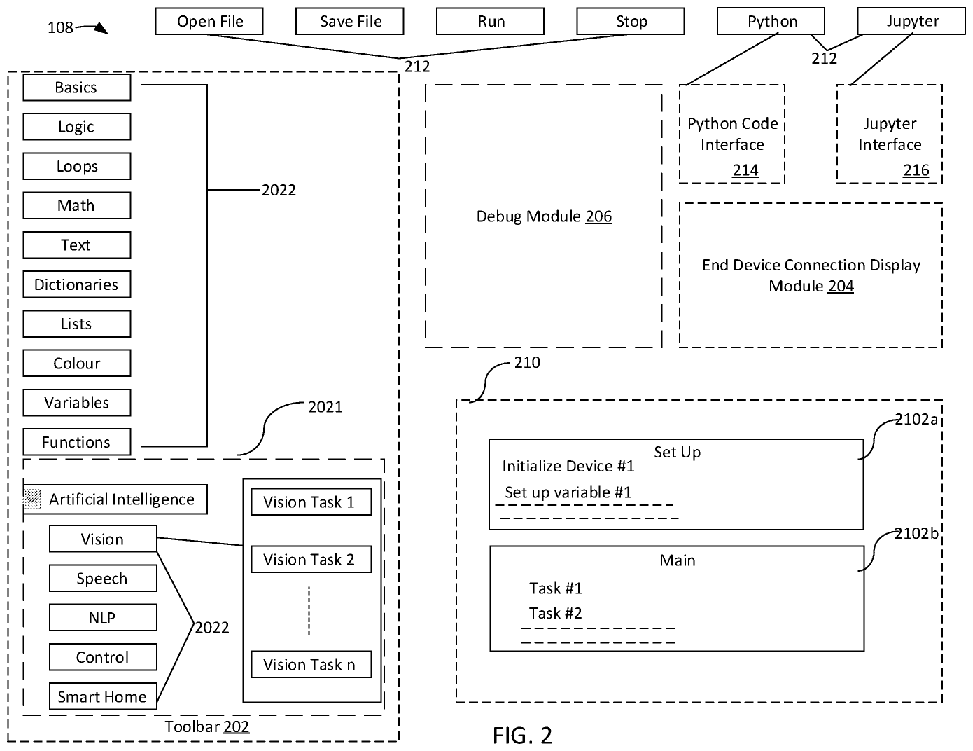

FIG. 2 illustrates an example of an interface 108 implemented on the user device 102 shown in FIG. 1A. As shown, in this example, the interface 108 includes a toolbar 202, an end device connection display module 204, a debug module 206, a program area 210, and/or any other components of the interface 108. The interface 108, in this example, is implemented to enable a user to provide a VPL-like input to cause the end device 106 to perform one or more tasks. The interface 108 thus provides the user a user-friendly and intuitive programming interface.

In this example, as shown, the toolbar 202 includes one or more program elements 2022. As used herein, a program element is referred to a graphical component in a user interface that can be manipulated by a user to provide an input or inputs. Examples of a program element may include a graphical button, an actionable area, a selectable menu, and/or any other graphical component in a user interface. Typically, a program element corresponds to an action which the user may select in the interface 108. Examples of a program element may include graphical component corresponding to basics, logic, loops, math, text, dictionaries, lists, color, variables, functions, and/or any other program elements, which may provide the user access to one or more predetermined coding. For example, the button “Variables”, in this example, indicates to the user that the user can select this program element to set up one or more variables for the one or more tasks the user would like for the end device 106 to perform. As another example, the program element “Text”, in this example, indicates to the user that the user can select this program element to provide a text input for the one or more tasks to be performed on the end device 106. Still as another example, the program element “Lists”, in this example, indicates to the user that the user can select this program element provide one or more lists for the one or more tasks to be performed on the end device 106.

Attention is now directed to area 2021 in the toolbar 202. In this example, program elements 2022 arranged in area 2021 correspond to artificial intelligence task categories of vision, speech, natural language processing (NLP), device control, and smart home control actions. As used herein, a task category is referred to a category of tasks logically grouped together and that can be performed on the end device 106. An individual task category can include one or more tasks to enable the user to locate one or more tasks in the task category for performance on the end device 106. For example, as shown here, the vision task category includes a list of tasks related to vision (e.g., vision processing, recognition, and/or any other tasks that may involve using an optical sensor) that can be performed on end device 106. The user may act on the program element “Vision”—for example by clicking on it, to show the list of vision tasks available for selection by the user. The list of the vision tasks may reflect one or more capabilities of the system 104 and/or the end device 106.

For example, vision task 1 may be a task “recognize a person's face” such that the user may select this task to cause the end device 106 to recognize a person's face. An individual task in the task category may represent a logic executable on the end device 106. For example, the task “recognize a person's face” represents a logic to cause the end device 106 to using one or more of its optical sensor to perform facial recognition of a person. This logic may include one or more preset instructions for performing the facial recognition of the person on end device 106. For instance, the preset instructions for recognizing a person's face using end device 106 may include initializing a cache for storing a result and/or status of the facial recognition, setting up a facial image processing for the facial recognition and/or any other instructions. Traditionally, such instructions are provided by the user using programming code such as Python. As mentioned, this would require the user to have knowledge about how the program the end device 106 to perform the facial recognition. One insight provided by the present disclosure is that such a task can be “canned” and provided to the user in the interface 108 as a program element 2022. The user can then select this program element 2022 to have the end device 106 perform the “canned” task corresponding to the program element 2022. In this way, the user can be saved from knowing details how to program the end device 106 to perform the task using a programming language such as Python.

In implementation, the user can be enabled to select a particular task category in the interface 108 by performing a manipulation such as pressing down a button at the interface 108 corresponding to a task category. In this example, the user selects the task category “vision”, then a corresponding sub-menu appears at the interface 108. As shown in FIG. 2, the sub-menu corresponding to the task category “vision” is configured to include a set of sub-tasks under the task category “vision”. In implementation, task category may be split into a set of tasks for easier tracking and completion. In this example, the sub-menu includes vision task 1, vision task 2, vision task n, and/or any other sub-tasks corresponding to the task category “vision”.

In some embodiments, tasks of a particular task category are a group of pre-determined tasks. Examples of a group of pre-determined tasks for the task category “vision” include vision initialization, vision function setup, addition of identity of a person, addition of an object, run face recognition, run image classification, vision result display setup, and/or any other sub-tasks.

In some other embodiments, tasks of a particular task category may be dynamic tasks. A dynamic task may be referred to a task of a particular task category wherein execution of the task is determined based on the computing capability of the integrated control architecture 100. In one example, a group of end devices 106 are connected to the system 104. Each end device 106 in the group corresponds to a dynamic task of the task category “vision”. In this example, execution of the dynamic tasks are determined based on the computing capability of the integrated control architecture 100. If the computing capability can support execution of all the dynamic tasks, then all the end devices 106 in the group are connected to the system 104. If the computing capability cannot support execution of all the dynamic tasks, then only some of the end devices 106 in the group are connected to the system 104.

It should be understood—although only one level of tasks are shown in FIG. 2, the example of “vision”, this is not intended to be limiting. In various implementation, more than one level of tasks may be made available to the user. For instance, the vision task 1 shown in this example may include a set of sub-tasks, which the user can select to cause the end device 106 to perform without having to perform one or more other sub-tasks in the set under vision task 1. It is understood that there can be multiple levels of sub-tasks available to the user for selection in the interface 108.

The interface 108 may be configured to allow the user to perform a user manipulation on one or more program elements 2022 in the interface 108. Examples of user manipulation on one or more program elements 2022 include drag and drop, voice control, gesture control, and/or any other types of user manipulations.

In various examples, the program elements 2022 may be manipulated to be dragged and dropped into program area 210 shown in FIG. 2. The program area 210 is an area where the user can provide one or more specific instructions about the one or more tasks for performance on end device 106. The user may select one or more program elements 2022 to provide the one or more specific instructions. As mentioned above, the tasks available for the user in interface 108 as program elements can represent preset logic for performing the task on the end device 106. The user may drag and drop multiple program elements 2022 to the program area 210 for performance an objective. For instance, the user may want to achieve an objective of “recognizing a person's face to know his/her name, and say a personalized welcome message to that person”. In that case, the user would drag and drop a program element 2022 corresponding to “recognizing a person's face”, select a program element 2022 “variables” to set up a variable for holding the person's name after the person's face is recognized and drag and drop a program element 2022 corresponding to “speak a personalized message” with the variable as the input. All of these instructions can be specified in the program area 210. In various examples, these instructions still represent a level of logic to program the end device 106 to achieve the objective and yet save the user from knowing programming details to program the end device 106. As mentioned, this is beneficial to teach a novice user such as a child to learn programming and not to inundate the child with programming details to overwhelm the child.

In implementation, as shown here, the program area 210 may include program blocks 2102, such as a setup block 2102a, a main block 2102b, and/or any other program blocks. In this example, the setup block 2102a is an area where the user can set up the end device 106, initialize various constructs and/or any other tasks for performing the one or more tasks. For example, if the user would like to have the end device 106 perform facial recognition on a person and provides the person's identity for display on user device 102, the user would first set up the end device 106 (for example, power on, initialize video capability, and/or any other tasks), one or more variables (for example, provide a variable for holding a result of the facial recognition, provide a variable for checking a status of the facial recognition, and/or any other variables) and/or any other setup tasks. As mentioned, for performing such set up tasks, the user is enabled by the interface 108 to simply select an appropriate program element 2022 in the tool bar 202 for manipulation in program area 210. For example, for setting up the variables, the user may select program element “Variables”, which prompts the user to set up a variable in the setup block 2102a.

In implementation, for a task category corresponding to a program element 2022, one or more rules may be configured. The one or more rules for the task category may represent overall requirements/restrictions/policies and/or any other considerations for the task category. For example, a set of one or more rules may be configured for the vision task category, which may include that a requirement that when a task in the vision task category is selected by the user for performance on the end device 106, the user should initialize a video capability on the end device 106 such as a camera on the end device 106. As shown early, the user may do this in the setup block 2102a in the program area 210. This rule may specify that if the user selects one vision task in the program area 210 for performance without initializing the video capability on the end device 106, an error message may be displayed in the interface 108 to prompt the user that the video capability should be initialized on end device 106 since a vision task is selected,

Another example of a rule for the task is that another task must or must not be selected for performance if this task is selected. For instance, a rule may be configured for smart home control task such voice control such that if a voice control task is selected, a speech task cannot be selected because the audio capability of the end device 106 (e.g. a microphone) cannot be shared between the two categories of tasks. As another example, a rule may be configured such that if a speech task is selected for performance on end device 106, a NLP task must also selected to process a speech captured by the speech task. Other examples are contemplated.

In implementation, a set of one or more rules for an individual task category or an individual task in the task category can be implemented in the client-side program 110, in the server-side program 112, in both the client-side program 110 and the server-side program 112, and/or in any other programs.

Still as another example for rules for the task category “vision”, execution of the task “vision initialization” is specified by the rule to precede execution of the sub-task “addition of identity of a person”. In this example, if the user performs a user manipulation to execute the task “addition of identity of a person” before the task “vision initialization”, an error message then appears in the interface 108 to notify an error of the user manipulation.

Also shown in interface 108 are set up elements 212. A setup element 212 in the interface 108 may be referred to an element of the interface 108 configured to set up basic functions to facilitate the user to have one or more tasks perform on the end device 106. In the embodiment shown in FIG. 2, the setup elements 212 include open file, save file, run, stop, Python, and Jupyter. In this embodiment, both Python and Jupyter setup elements allow the user to transit to an exploratory programming interface. An exploratory programming interface may be referred to a programming interface configured to allow the user to interactively develop and debug a program without having to go through the usual constraints of an edit-compile-run-debug cycle. In implementation, a button function corresponding to a setup element 212 may be configured to enable the user to select the setup element 212. In one example, the user performs a user manipulation on the setup element “Python” by pressing down a “Python” button in the interface 108. A Python code interface 214 then appears in the interface 108. The Python code interface 214 may be an exploratory programming interface configured to include a Python code corresponding to a specific task category selected by the user. In this example, the Python code interface 214 allows the user to visualize and edit the Python code corresponding to the specific task category selected by the user. Modification of the Python code in the Python code interface 214 allows the user to customize instructions for a specific task category.

In another example, the user performs a user manipulation on the setup element “Jupyter” by pressing down a “Jupyter” button. A Jupyter interface 216 then appears in the interface 108. A Jupyter interface 216 may be referred to an exploratory programming interface with an interactive web tool combining software code, computational output, explanatory text and multimedia resources in a single document. In this example, the Jupyter interface 216 allows the user to visualize and edit a program code corresponding to a specific task category, observe computational outputs from a specific task category, obtain explanatory text of a specific task category, and/or perform any other functions in the Jupyter interface 216.

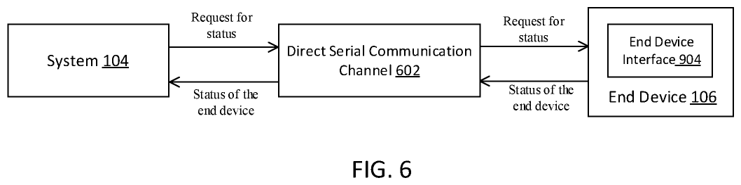

Still shown in interface 108 is a device connection display module 204, which may be referred to a display module at the interface 108 configure to display a list of end devices 106 connected to the system 104. In some embodiments, a set of end devices 106 are automatically connected to the system 104 without user manipulations at the interface 108. In this way, novice user such as a child can connect one or more end devices 106 to the system 104 without configuring details of communication between the end devices 106 and the system 104. In some other embodiments, the end device connection display module 204 allows the user to enable/disable one or more end devices 106 from a list of available end devices 106. Please reference FIG. 6 and its associated texts for an example of connection between the end device 106 and the system 104.

Also shown in interface 108 is a debug module 206, which may be referred to a module at the interface 108 configured to enable the user to detect and remove existing and potential errors in execution of the client-side program 110, the server-side program 112, and/or any other programs in the integrated control architecture 100. In some embodiments, the debug module 206 displays a first code understandable to the system 104 corresponding to a user manipulation at the interface 108. The displayed first code understandable to the system 104 in the debug module 206 allows the user to detect and remove errors in the code. For example, the first code understandable to the system 104 can include a Python code representing the one or more specific instructions provided by the user in the program area 210. In some other embodiments, the debug module 206 is configured to highlight the current program block being executed in the program area 210. In this way, the debug module 206 is then configured to move the highlight to a next program block only when the result of the current program block is returned.

The debug module 206 can be used to assist the user to debug the one or more specific instructions provided by the user in the program area 210. As mentioned, one or more rules may be configured for the program elements 2022 corresponding to tasks that can be manipulated in the program area 210. Those rules may not still ensure the one or more tasks intended by the user to be performed on end device 106 to run successfully. For example, a run-time error may still occur on end device 106 even after the one or more instructions are run on the end device 106. In a sense, the rules for the tasks may be understood as a type of “compile-time” error check, which does not necessarily guarantee run-time success. The debug module 206 thus can be provided to the user to enable the user debug the one or more tasks to ensure one or more logic in the one or more instructions provided by the user in the program area 210 can be run successfully as intended. In various implementation, after the user act on the debug module 206, the one or more code representing the one or more tasks may be modified directly by the user.

In another example, the user selects the task category “smart home” and performs a user manipulation of the task “addition of identity of a person”. In this example, the debug module 206 is configured to display a first code understandable to the system 104 corresponding to the selected task category “smart home” and the task “addition of identity of a person”. An error indicator in the debug module 206 is then used to locate beginning of a code corresponding to the task “addition of identity of a person”. In this example, the debug module 206 is configured to display a message “Incompatible sub-task selected. Please select a sub-task compatible to the task category Smart Home.” to indicate an error in the user manipulation.

### Example Software Architecture

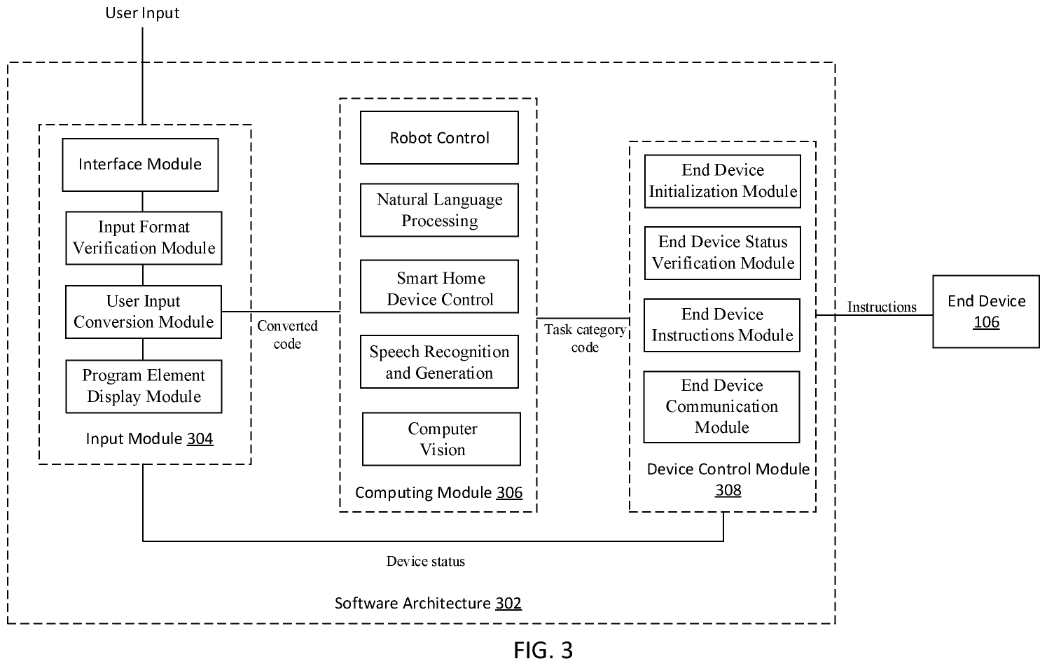

FIG. 3 illustrates an embodiment of a software architecture 302 of the integrated control architecture 100. A software architecture 302 may be referred to a fundamental structure of a software system of the integrated control architecture 100. As shown, in this embodiment, the software architecture 302 comprises an input module 304, a computing module 306, a device control module 308, and/or any other modules in the software architecture 302. An input module 304 may be referred to a module in the software architecture 302 used for receiving/obtaining and configuring one or more user inputs in the software architecture 302. In this embodiment, the user input received/obtained in the input module 304 comprises a user manipulation in the interface 108.

In this embodiment, the input module 304 includes an interface module, an input format verification module, a user input conversion module, a program element display module, and/or any other modules. An interface module may be referred to a sub-module in the input module 304 used for executing functions related to user manipulations at the interface 108. In one example, the user performs a user manipulation at the interface 108 to select the specific task category “vision”. The user manipulation for selecting the task category “vision” is then received as an input in the interface module. The interface module then calls corresponding setup functions in the server-side program 112 for performing the task category “vision”. Algorithm 1 illustrates an example of pseudocode of the interface module for receiving/obtaining a user manipulation from the interface 108.

Algorithm 1 Example of pseudo code of the
interface module in the input module 304.

```
INPUT User_manipulation
WHILE TRUE:
  event = User_manipulation
  IF (event == None)
    DO nothing
  IF (event == Vision)
    Vision_Setup( )
  IF (event == Speech)
    Speech_Setup( )
  IF (event == NLP)
    NLP_Setup( )
  IF (event == Control)
    Control_Setup( )
  IF (event == Smart_Home)
    Smart_Home_Setup( )
```

An input format verification module may be referred to a sub-module in the input module 304 used for verifying a set of rules for user manipulations at the interface 108. In one example, a set of rules for user manipulations of the task category “vision” comprise a specific order of execution of sub-tasks in the task category “vision”. In this example, the correct order of execution of sub-tasks in the task category “vision” is: “vision initialization”, “vision function setup”, “addition of identity of a person”, “run face recognition”, “vision result display setup”. If the user performs a user manipulation at the interface 108 to execute the sub-tasks in the task category “vision” in an order different from the correct order of execution, then an error message appears in the interface 108 to notify an error of the user manipulation. Algorithm 2 illustrates an example of pseudocode for sub-task execution order verification.

Algorithm 2 Example of pseudocode for
sub-task execution order verification.

```
INPUT Array [User_subtask_1, ... , User_subtask_n]
DEFINE Correct_Order = Array[Correct_subtask_1, ... ,
Correct_subtask_m]
User_Order = Array[User_subtask_1, ... , User_subtask_n]
n = size(User_Order)
verif = True;
if (n>1)
  for (i=2, i<=n, i++)
    index = index_find(User_Order[i], Correct_Order)
    index_prev = index_find(User_Order[i-1], Correct_Order)
    if (index < index_prev)
      verif = False;
      break;
int index_find (elem, array) {
  for (j=0, j<=size(array), j++)
    if elem == array[j]
      ind = j;
  return ind;
}
RETURN verif
```

In another example, a set of rules for user manipulations of the task category “vision” comprise verification of correct sub-tasks under the task category “vision”. In this example, the task category “vision” includes a set of sub-tasks: “vision initialization”, “vision function setup”, “addition of identity of a person”, “run face recognition”, “run image classification”, and “vision result display setup”. The example set of rules are configured to verify that only the sub-tasks under the task category “vision” are executed when the user selects the task category “vision”. In this example, if the user selects a task category other than the task category “vision” and performs a user manipulation of one or more sub-tasks under the task category “vision”, then an error message appears in the interface 108 to notify an error of user manipulation. Likewise, if the user selects the task category “vision” and performs a user manipulation of a sub-task under another task category, then an error message appears in the interface 108. Algorithm 3 illustrates an example of pseudocode for sub-task correctness verification.

Algorithm 3 Example of pseudocode for
sub-task correctness verification.

```
INPUT Task_Category, Array[User_subtask_1, ... , User_subtask_n]
DEFINE Task_Category_1 = Array[Subtask_1_1, ... , Subtask_1_ml]
.
.
.
DEFINE Task_Category_n = Array[Subtask_n_1, ... , Subtask_n_mn]
List_Category = [‘Task_Category_1’,...,‘Task_Category_n’]
Category = cat_find(Task_Category, List_Category)
sub_task_all = Array[User_subtask_1, ... , User_subtask_n]
n = size(sub_task_all)
verif = True;
for (i=1, i<=n, i++)
  sub_task = sub_task_all[i]
  if (sub_task not in Category)
    verif = False;
    break;
char cat_find(Task_Category, List_Category) {
  for (j=0, j<=size(List_Category), j++)
    if Task_Category == List_Category[j]
      ind = List_Category[j];
  return ind;
}
RETURN verif
```

In some embodiments, a set of rules for user manipulations at the interface 108 comprise rules for determining a number of end devices 106 to be connected to the system 104 for performing one or more task categories. In these embodiments, the set of rules are configured to provide a pre-determined number of end devices 106 to be connected to the system 104. If amount of available end devices 106 exceeds the pre-determined number of end devices 106, then the set of rules are configured to select the pre-determined number of end devices 106 to be connected to the system 104.

In some other embodiments, the set of rules for determining the number of end devices 106 to be connected to the system 104 are dynamically determined by a capability of the system 104. A capability of the system 104 may be referred to an ability to execute one or more functions in the system 104. Examples of capability of the system 104 include computing resources, computing power, memory capacity, and/or any other types of capability. In these embodiments, each end device 106 is configured to require an amount of capability in order to perform a specific task. Based on the amount of capability associated with each end device 106 and the capability of the system 104, the set of rules may be configured to enable/disable one or more end devices 106. Algorithm 4 illustrates an example of pseudocode for dynamically determining the number of end devices 106 to be connected to the system 104.

Algorithm 4 Example of pseudocode for dynamically determining the
number of end devices 106 to be connected to the system 104.

```
INPUT system_capability, list_end_device
list_end_device[1,..., n].enable = False; //Set default end device enable
value
n = size(list_end_device);
needed_capability = sum(list_end_device[1,...,n].capability);
if (needed_capability <= system_capability)
  list_end_device[1,...,n].enable = True ;
else
  current_capability = 0;
  for (i=1, i<=n, i++)
    current_capability += list_end_device[i].capability;
    if (current_capability <= system_capability)
      list_end_device[i].enable = True;
    else
      break;
RETURN list_end_device[1,...,n].enable
```

The user input conversion module may be referred to a sub-module in the input module 304 used for converting user manipulations at the interface 108 to a first code understandable to the system 104. Examples of first code understandable to the system 104 include Python, C, C++, JavaScript, and/or any other types of code understandable to the system 104. The program element display module may be referred to a sub-module in the input module 304 used for displaying a first code understandable to the system 104 at the interface 108.

In one example, the user performs a user manipulation at the interface 108 to select the task category “vision”. The user manipulation is sent to the interface module of the input module 304 as an input. As shown in Algorithm 1, the interface module accepts the user manipulation and calls a vision setup procedure for executing a set of setup functions associated with the task category “vision”. The setup functions associated with the task category “vision” may be stored in a storage element of the system 104, and/or any other storage elements in the integrated control architecture 100. Examples of setup functions associated with the task category “vision” include vision initialization, vision function setup, and/or any other setup functions. The setup functions associated with the task category “vision” may be executed by the client-side program 110, the server-side program 112, and/or any other programs in the integrated control architecture 100.

In this example, after selecting the task category “vision”, the user performs a user manipulation at the sub-menu of the task category “vision” to select the sub-task “addition of identity of a person”. As shown in Algorithms 2 and 3, the input format verification module is configured to verify the user manipulation at the sub-menu for selecting the sub-task “addition of identity of a person”. In this example, the user input conversion module is configured to convert the user manipulations of the task category “vision” and the sub-task “addition of identity of a person” to a first code understandable to the system 104. The conversion to a first code understandable to the system 104 may be executed by the client-side program 110, the server-side program 112, and/or any other programs in the integrated control architecture 100. Algorithm 5 illustrates an example of pseudocode for a converted code for selecting the sub-task “addition of identity of a person”.

Algorithm 5 Example of pseudocode for a converted code for selecting
the sub-task “addition of identity of a person”.

```
INPUT Task_Category, Array[User_subtask_1, ... , User_subtask_n],
person_pic, person_id
if (Task_Category == Vision)
  Vision_Setup( );
  if (any(Array[User_subtask_1, ... ,
  User_subtask_n])!=Add_id_pserson)
    print(‘Please add person identity’);
  else
    input_image = input_image.append(person_pic);
    input_id = input_id.append(person_id);
RETURN input_image, input_id
```

A computing module 306 may be referred to a module in the software architecture 302 configured to compute one or more codes corresponding to one or more task categories. Examples of code corresponding to one or more task categories may include robot control code, natural language processing code, smart home device control code, speech recognition and generation code, computer vision code, and/or any other types of codes corresponding to one or more task categories.

A device control module 308 may be referred to a module in the software architecture 302 configured to control one or more end devices 106. In some embodiments, the device control module 308 comprise an end device initialization module, an end device status verification module, an end device instruction module, and end device communication module, and/or any other modules for end device control.

An end device initialization module may be referred to a sub-module in the device control module 308 configured to initialize one or more the end devices 106 corresponding to one or more specific task categories. An end device status verification module may be referred to a sub-module in the device control module 308 configured to verify status of one or more end devices 106. An end device instructions module may be referred to a sub-module in the device control module 308 configured to enable an end device 106 to perform one or more instructions. An end device communication module may be referred to a sub-module in the device control module 308 configured to set up communications between one or more end devices 106 and any other devices/systems in the integrated control architecture 100. Examples of an end device communication module may include a communication initialization function, a protocol setup function, a source setup function, a destination setup function, a communication status check function, and/or any other types of functions.

In one example, the user performs a user manipulation at the interface 108 to select a task category “vision” and a set of sub-tasks: “vision initialization”, “vision function setup”, “run face recognition”. The interface module at the input module 304 is then configured to read the user manipulation as an input and select “vision” as the event as shown in Algorithm 1. The input format verification module is configured to verify format of the user manipulation, and the user input conversion module is configured to convert the user manipulation to a first code understandable to the system 104.

In this example, when the user selects the sub-task “run face recognition”, the face recognition code in the computing module 306 is executed to perform the sub-task “run face recognition”. Execution of the face recognition code may be performed in the client-side program 110, the server-side program 112, and/or any other programs in the integrated control architecture 100. In this example, the end device instructions module in the device control module 308 is operatively connected to the computing module 306 to provide one or more inputs for executing the face recognition code. An example of input for executing the face recognition code may be an array of face imagery data received/obtained by one or more end devices 106. The one or more end devices 106 in this example are image sensors configured to receive/obtain face imagery data. The face recognition code may be configured to provide an output corresponding to an identified individual. Algorithm 6 illustrates an example of pseudocode for execution of the sub-task “run face recognition”.

Algorithm 6 Example of pseudocode for execution
of the sub-task “run face recognition”.

```
INPUT Task_Category, Array[User_subtask_1, ... , User_subtask_n],
input_face_image, face_dictionary
if (Task_Category == Vision)
  Vision_Setup( );
  if (any(Array[User_subtask_1, ... ,
  User_subtask_n])==run_face_recognition)
    predict_id = run_face_recognition(input_face_image,
    face_dictionary)
RETURN predict_id
```

As shown in Algorithm 6, in this example, a face dictionary is used in the face recognition code for identifying an individual from input imagery data. A face dictionary may be referred to an organized collection of data comprising identity and face imagery data of a set of individuals. TABLE 1 illustrates an example of a face dictionary. The first column in TABLE 1 shows identity of individuals. Examples of identity of individuals include name, gender, and/or any other types of identity. The second column in TABLE 1 shows imagery data of individuals. In this example, the sub-task “run face recognition” is configured to assign an individual identity to the input face imagery data by searching in the face dictionary an identity with the most similar imagery data.

TABLE 1
Example of a face dictionary.

| Individual Identity | Imagery data |
|---|---|
| Identity_1 | Imagery_data_1 |
| Identity_2 | Imagery_data_2 |
| . | . |
| . | . |
| . | . |
| Identity_n | Imagery_data_n |

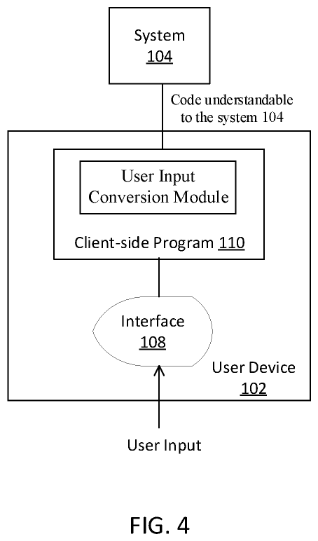

FIG. 4 illustrates another example for the user input conversion module in the input module 304. As shown, the user input conversion module is implemented in the client-side program 110. In this example, the user performs a user manipulation at the interface 108 to select a specific task category. The user input conversion module is then configured to receive/obtain the user manipulation and identify the corresponding task category. Based on the identified task category, the user input conversion module is configured to convert the user manipulation to a first code understandable to the system 104. Example of a first code understandable to the system 104 may be a JavaScript code. Algorithm 7 illustrates an example of JavaScript code for identifying a selected task category at the interface 108.

Algorithm 7 Example of JavaScript code for identifying
a selected task category at the interface 108.

```
<!DOCTYPE HTML>
<html>
  <head>
    <title>
      Get the task category corresponding to the clicked button using
      jQuery
    </title>
    <script src =
“https://ajax.googleapis.com/ajax/libs/jquery/3.4.0/jquery.min.js”>
    </script>
  </head>
  <body style = “text-align:center;”>
    <h1 style = “color:green;” >
      Artificial Intelligence
    </h1>
    <p id = “UP” style =
      “font-size: 15px; font-weight: bold;”>
    </p>
    <button id=“1”> Vision</button>
    <button id=“2”> Speech</button>
    <button id=“3”> NLP</button>
    <button id=“4”> Control</button>
    <button id=“5”> Smart Home</button>
    <p id = “DOWN” style =
      “color:green; font-size: 20px; font-weight: bold;”>
    </p>
    <script>
      $(‘#UP’).text(“Select Task Category”);
      $(“button”).on(‘click’,function( ) {
        var t = (this.id);
        $(‘#DOWN’).text(“Selected Task Category is: ” + t);
      });
    </script>
  </body>
</html>
```

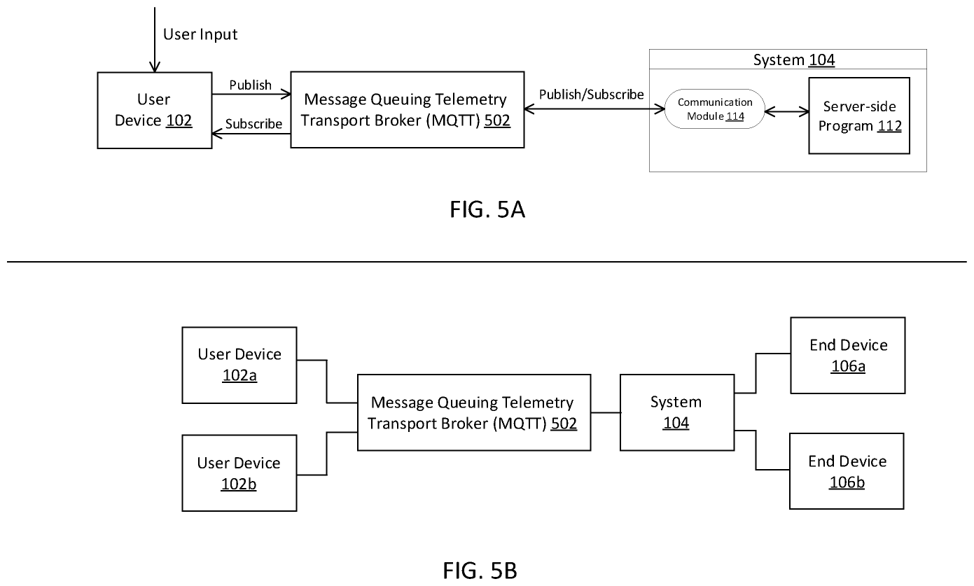

FIG. 5A illustrates an example of an MQTT broker 502 for facilitating communication between one or more user devices 102 and one or more systems 104. An MQTT broker 502 may be referred to an intermediary computer program module that translates a message from a formal messaging protocol of a sender to a formal messaging protocol of a receiver using a publish-subscribe network protocol. In this example, the MQTT broker 502 is operatively connected to the user device 102 and the system 104. The goal of using an MQTT broker 502 is to provide ordered, lossless, and bi-directional connection between the user device 102 and the system 104.

FIG. 5B illustrates another example of the MQTT broker 502. In this example, user device 102a and user device 102b are connected to system 104 through the MQTT broker 502. In this example, the user device 102a is configured to perform a sub-task “vision task 1”, and the user device 102b is configured to perform a sub-task “vision task 2” under the task category “vision”. The sub-tasks “vision task 1” and “vision task 2” are performed by the system 104, the end device 106a, and the end device 106b.

In this example, each user device 102 publishes a message at the MQTT broker 502 for connecting to the system 104. Example of a published message from the user device 102a may include “sub-task needed at user device 1: vision task 1”. The system 104 subscribes a topic at the MQTT broker 502 for connecting to a corresponding user device 102. Example of a subscribed message from the system 104 may include “system 1 and end device 1 available for: vision task 1”. The MQTT broker 502 is configured to mediate communication between the user devices 102 and the systems 104. In this way, the MQTT broker 502 allows users of the integrated control architecture 100 to improve available communication bandwidth between the user devices 102 and the systems 104. Algorithm 8 illustrates an example of pseudocode for the MQTT broker 502.

Algorithm 8 Example of pseudocode for the MQTT broker 502.

```
clientId_1 = “UD1”
clientId_2 = “UD2”
clientId_3 = “S1”
clientId_4 = “S2”
device_name1 = “User_Device_1”
device_name2 = “User_Device_2”
device_name3 = “System_1”
device_name4 = “System_2”
#display all incoming messages
def on_message(client, userdata, message):
  payload = DECODE_MESSAGE_PAYLOAD( )
  print(“ < received message ” + payload)
# publish a message
def publish(topic, message, wait_for_ack = False):
  QoS = 2 if wait_for_ack else 0
  message_info = CLIENT_PUBLISH(topic, message, QoS)
  if wait_for_ack:
    print(“ > awaiting ACK for { }”.format(message_info.mid))
    message_info.wait_for_publish( )
    print(“ < received ACK for { }”.format(message_info.mid))
# display all outgoing messages
def on_publish(client, userdata, mid):
  print(“ > published message: { }”.format(mid))
# connect the client
client_1 = MQTT_CLIENT(clientId_1)
client_1.on_message = on_message
client_1.on_publish = on_publish
publish(device_name1, wait_for_ack = True)
client_1.subscribe(“s/ds”)
client_2 = MQTT_CLIENT(clientId_2)
client_2.on_message = on_message
client_2.on_publish = on_publish
publish(device_name2, wait_for_ack = True)
client_2.subscribe(“s/ds”)
client_3 = MQTT_CLIENT(clientId_3)
client_3.on_message = on_message
client_3.on_publish = on_publish
publish(device_name3, wait_for_ack = True)
client_3.subscribe(“s/ds”)
client_4 = mqtt.Client(clientId_4)
client_4.on_message = on_message
client_4.on_publish = on_publish
publish(device_name4, wait_for_ack = True)
client_4.subscribe(“s/ds”)
```

FIG. 6 illustrates an embodiment for a direct serial communication channel 602. As shown, in this embodiment, the system 104 is operatively connected to the end device 106 through the direct serial communication channel 602. A direct serial communication channel 602 may be referred to a communication medium between devices wherein data transmission is accomplished sequentially one bit at a time. Examples of direct serial communication channel 602 include Bluetooth, universal serial bus, recommended standard (RS)-232, serial peripheral interface, peripheral component interconnect express, and/or any other types of direct serial communication channels.

In this embodiment, the end device 106 is configured to include an end device interface 904 to display available devices to connect via the direct serial communication channel 602. An end device interface 904 may be referred to a part of the end device 106 where interactions between the end device 106 and the user occur. The end device interface 904 may be configured to allow the user to perform a user manipulation at the end device interface 904 in order to connect a device to the end device 106 via the direct serial communication channel 602. As shown in FIG. 2, an end device connection display module 204 may be used to display a list of end devices 106 connected to the system 104 at the interface 108.

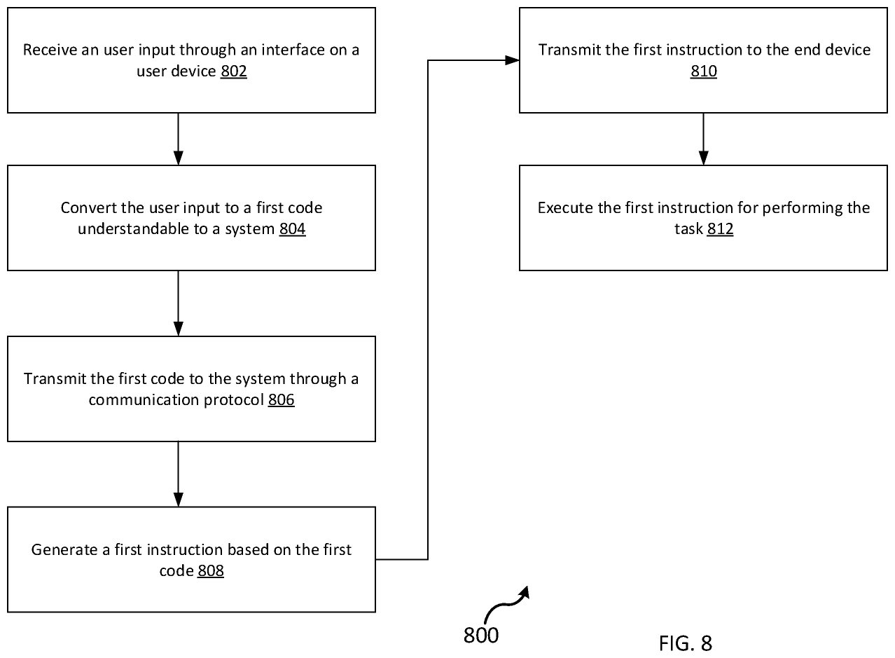

FIG. 8 illustrates an example method 800 for facilitating a user to cause an end device to perform one or more tasks in accordance with the disclosure. The operations of method 800 presented below are intended to be illustrative. In some embodiments, method 800 may be accomplished with one or more additional operations not described and/or without one or more of the operations discussed. Additionally, the order in which the operations of method 800 are illustrated in FIG. 8 and described below is not intended to be limiting.

In some embodiments, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

At an operation 802, a user input is received though an interface on a user device. In various embodiments, the user input received at 802 is an instruction provided by the user through the interface 108 illustrated and described herein. In those embodiments, the user input is an instruction to cause the end device 106 to perform one or more tasks through system 104 described and illustrated herein.

At an operation 804, the user input received at 802 is converted to a first code understandable a system. In various embodiments, the system is the system 104 illustrate and described herein. In various implementation, operation 804 is performed by a user input module similar to or the same as the one described and illustrated herein.

At an operation 806, the first code is transmitted to the system through a communication protocol. In various implementation, operation 806 is performed by a user input module similar to or the same as the one described and illustrated herein.

At an operation 808, the first instruction is generated based on the first code on the system. In various implementation, operation 808 is performed by an end device instruction module similar to or the same as the one described and illustrated herein.

At an operation 810, the first instruction is transmitted to the end device. In various implementation, operation 810 is performed by an end device communication module similar to or the same as the one described and illustrated herein.

At an operation 812, the first instruction is executed on the end device. In various implementation, operation 812 is performed by an end device 106 similar to or the same as the one described and illustrated herein.

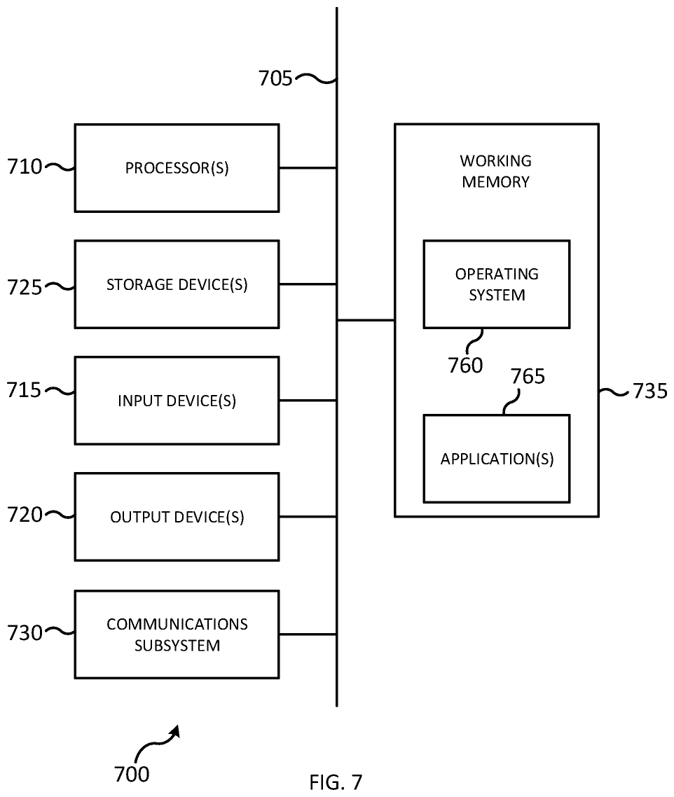

FIG. 7 illustrates a simplified computer system that can be used to implement various embodiments described and illustrated herein. A computer system 700 as illustrated in FIG. 7 may be incorporated into devices such as a portable electronic device, mobile phone, or other device as described herein. FIG. 7 provides a schematic illustration of one embodiment of a computer system 700 that can perform some or all of the steps of the methods provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. The computer system 700 is shown comprising hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, an 702.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g. the first electronic device, may be incorporated into the computer system 700, e.g., an electronic device as an input device 715. In some embodiments, the computer system 700 will further comprise a working memory 735, which can include a RAM or ROM device, as described above.

The computer system 700 also can include software elements, shown as being currently located within the working memory 735, including an operating system 760, device drivers, executable libraries, and/or other code, such as one or more application programs 7105, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the procedures of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

1. A method for enabling a user to program a system in real time to perform a task on an end device, the method being implemented in an electronic processor, and the method comprising:
receiving, at a user device, an user input from the user through an interface on the user device, the interface being configured to enable the user to manipulate one or more program elements graphically, wherein the one or more program elements include a first program element corresponding to the task, and the user input is provided by the user through a user manipulation of the first program element in the interface, the user manipulation comprising user selection and drag and drop;
converting, at the user device, the user input to a first code understandable to the system;
transmitting, at the user device, the first code to the system through a communication protocol;
generating, at the system, a first instruction based on the first code;
transmitting, at the system, the first instruction to the end device; and
executing, at the end device, the first instruction for performing the task, and
receiving, at the user device, the real-time status of both the end device and the task being performed at the end device through a communication module.

2. The method of claim 1, wherein the first instruction facilitates at least a part of a human intelligence process including:
robot control;
natural language processing;
smart home device control;
speech recognition;
face recognition; or
image classification.

3. The method of claim 1, wherein converting, at the user device, the user input to the first code understandable to the system comprises:
verifying, at the user device, a format of the user input;
interacting, at the user interface, with the user by updating display of the one or more program elements at the interface in response to events from the user input; and
converting, at the system, the events from the user input to the first code understandable to the system.

4. The method of claim 1, further comprising:
initializing, at the system, the end device;
verifying, at the system, a status of the end device; and
sending, at the system, instructions to the end device.

5. The method of claim 1, wherein the communication protocol is a publish-subscribe network protocol transporting messages between the user device and the system through an ordered, lossless, and bi-directional connection.

6. The method in claim 4, further comprising:
receiving, through the communication module, a request for status of the end device from the user device via a first communication channel;
transmitting the request for status of the end device from the communication module to the end device via a second direct serial communication channel;
obtaining, in the communication module, the status of the end device from the end device via the second direct serial communication channel; and
transmitting the status of the end device from the communication module to the user device via the first communication channel.

7. The method of claim 1, wherein the conversion, at the user device, of the user input to a first code understandable to the system is implemented by language specialized to an application domain of global system of interconnected computer networks.

8. The method of claim 1, wherein the user interface includes a section indicating selectable tasks for execution, and wherein the task is a selectable task representing a predetermined logic for execution on the end device.

9. The method of claim 1, wherein the user interface includes a section displaying the first code corresponding to the task.

10. A system for enabling a user to program control a system to perform a task on an end device, the system comprising one or more electronic processors configured to execute machine readable instructions such that when machine-readable instructions are executed, the system is caused to perform:
receiving an user input from the user through an interface, the interface being configured to enable the user to manipulate one or more program elements graphically, wherein the one or more program elements include a first program element corresponding to the task, and the user input is provided by the user through a user manipulation of the first program element in the interface, the user manipulation comprising user selection and drag and drop;
converting the user input to a first code understandable to the system;
transmitting the first code to the system through a communication protocol;
generating a first instruction based on the first code;
transmitting the first instruction to the end device;
executing the first instruction for performing the task; and
receiving, at the user device, the real-time status of both the end device and the task being performed at the end device through a communication module.

11. The system of claim 10, wherein the first instruction facilitates at least a part of a human intelligence process including:
robot control;
natural language processing;
smart home device control;
speech recognition;
face recognition; or
image classification.

12. The system of claim 10, wherein converting the user input to the first code understandable to the system comprises:
verifying a format of the user input;
interacting with the user by updating display of the one or more program elements at the interface in response to events from the user input; and
converting the events from the user input to the first code understandable to the system;

13. The system of claim 10, wherein the execution of the machine-readable instructions further causes the system to perform:
initializing the end device;
verifying a status of the end device;
sending instructions to the end device.

14. The system of claim 10, wherein the communication protocol is a publish-subscribe network protocol transporting messages through an ordered, lossless, and bi-directional connection.

15. The system in claim 14, wherein the execution of the machine-readable instructions further causes the system to perform:
receiving, through the communication module, a request for status of the end device from the user device via a first communication channel;
transmitting the request for status of the end device from the communication module to the end device via a second direct serial communication channel;
obtaining, in the communication module, the status of the end device from the end device via the second direct serial communication channel; and
transmitting the status of the end device from the communication module via the first communication channel.

16. The system of claim 10, wherein the conversion, at the user device, of the user input to a first code understandable to the system is implemented by language specialized to an application domain of global system of interconnected computer networks.

17. The system of claim 10, wherein the user interface includes a section indicating selectable tasks for execution, and wherein the task is a selectable task representing a predetermined logic for execution on the end device.

18. The system of claim 10, wherein the user interface includes a section displaying the first code corresponding to the task.
